(19) United States
(12) Patent Application Publication
(10) Pub. No.: US 2026/0335925 A1
(43) Pub. Date: Oct. 29, 2026

(54) APPLICATION DEVICE AND METHOD FOR APPLYING A FLUID

(71) Applicant: Gabriel WOHLGEMUTH, Sarentino (IT)

(72) Inventor: Gabriel WOHLGEMUTH, Sarentino (IT)

(21) Appl. No.: 19/697,709

(22) Filed: Jun. 4, 2026

Related U.S. Application Data
(63) Continuation of application No. PCT/EP2024/085057, filed on Dec. 6, 2024.

(30) Foreign Application Priority Data
Dec. 6, 2023 (DE) 10 2023 134 134.0

(51) Int. Cl. B05C 11/10; F16K 31/12

(52) U.S. Cl. CPC B05C 11/1026; F16K 31/12

(57) ABSTRACT

An application device for applying application fluid to an object, which device is easy to assemble and inexpensive to produce, and which can be operated in a wear-free manner, with little maintenance and installation, it is proposed that the application device comprises one application unit or a plurality of application units, wherein each application unit comprises a plurality of closure units for selectively enabling or closing a plurality of fluid outlet channels; and at least one application fluid channel for supplying application fluid to the closure units; and one valve unit or a plurality of valve units for actuating the closure units.

### RELATED APPLICATION

This application is a continuation of international application No. PCT/EP2024/085057 filed on Dec. 6, 2024, and claims the benefit of German application No. DE 10 2023 134 134.0 filed on Dec. 6, 2023, which are incorporated herein by reference in their entirety and for all purposes.

### FIELD OF DISCLOSURE AND BACKGROUND

The present invention relates to an application device and a method for applying a fluid to an object, in particular for applying cement paste to a sand bed.

### SUMMARY OF THE INVENTION

The present invention is based on the object of providing an application device for applying application fluid, which device is easy to assemble and can be produced at low cost. In addition, the present invention is based on the object of providing an application device which can be operated without wear, with little maintenance and with little installation.

This object is achieved according to the invention by an application device with the features as claimed in claim 1. Accordingly, the application device comprises one or more application units, wherein each application unit comprises: a plurality of closure units for selectively enabling or closing a plurality of fluid outlet channels; and at least one application fluid channel for supplying application fluid to the closure units; and one or more valve units for actuating the closure units.

In particular, the application fluid can be cement paste or wood glue or any fluidic process material.

The application device comprises, for example, at least one application unit. The application device preferably comprises at least two application units. In particular, the application device comprises a multiplicity of application units.

It can be advantageous if the application device comprises a plurality of application units. The plurality of application units preferably each comprise an application fluid channel.

It can be advantageous if an application unit comprises a plurality of closure units, an application fluid channel and a plurality of valve units. It can be advantageous if the application device comprises a plurality of application units, wherein each application unit comprises the same number of fluid outlet channels, closure units and/or valve units. Furthermore, provision can also be made for an application device to comprise a plurality of application units, wherein each application unit comprises a different number of fluid outlet channels, valve units and/or closure units.

Each application unit can comprise, for example, at least one closure unit and at least one valve unit. It can be favorable if the application unit comprises at least two closure units and at least two valve units. The application unit preferably comprises a multiplicity of closure units and a multiplicity of valve units. In particular, the number of valve units and the number of closure units can be identical. Provision can also be made for the number of valve units in the application unit to differ from the number of closure units.

The application fluid channel can comprise a plurality of fluid outlet channels. A fluid outlet channel can, in particular, comprise an inlet opening and an outlet opening.

The fluid outlet channel can, for example, extend transversely with respect to a main direction of extent. In particular, the main direction of extent extends parallel to an outer edge of the application unit. The fluid outlet channel can, for example, extend perpendicularly with respect to the main direction of extent. It can be advantageous if the fluid outlet channel is fluidically connected to the application fluid channel. The fluid outlet channel is preferably arranged directly below the application fluid channel. In particular, the fluid outlet channel extends at least approximately perpendicularly with respect to the main direction of extent directly below the application fluid channel.

Preferably, a fluid outlet channel is a nozzle or opens into a nozzle. The nozzle can comprise or form the inlet opening at one end and the outlet opening at a further end. The nozzle extends, in particular, from the inlet opening as far as the outlet opening. Preferably, the inlet opening is arranged in the application fluid channel or faces said application fluid channel. The outlet opening is preferably arranged on an application side of the application unit. In particular, the outlet opening faces away from the application fluid channel. In particular, the nozzle extends at least approximately perpendicularly with respect to the main direction of extent between the application fluid channel and the application side of the application unit.

It can be favorable if the nozzle is of cylindrical design.

It can be provided that the inlet opening and the outlet opening each have a circular cross section. As an alternative to this, provision can be made for the outlet opening to have any other desired geometries. For example, the outlet opening can be of rectangular, oval or polygonal design. It can be favorable if the outlet opening and the inlet opening have different cross sections. Alternatively, the outlet opening and the inlet opening can have an at least approximately identical cross section.

The outlet opening and the inlet opening preferably form mutually opposite ends of a fluid outlet channel. The outlet opening of the fluid outlet channel can be arranged on the application side of the application unit. It can be favorable if the outlet opening is arranged directly below the inlet opening. The fluid outlet channel preferably extends between the inlet opening and the outlet opening. The fluid outlet channel preferably forms a fluidic connection between the application fluid channel and the application side of the application unit.

In one embodiment, provision can be made for the fluid outlet channel to have a uniform cross section between the outlet opening and the inlet opening. As an alternative to this, it can be provided that the fluid outlet channel does not have a uniform cross section between the inlet opening and the outlet opening.

It can be favorable if the fluid outlet channel is arranged obliquely with respect to the main direction of extent. In particular, the fluid outlet channel is arranged at least approximately perpendicularly with respect to the main direction of extent.

The application unit preferably comprises a plurality of fluid outlet channels. In particular, the fluid outlet channels can be oriented at least approximately perpendicularly with respect to the main direction of extent of the application unit and/or can be arranged linearly one after the other along the main direction of extent. In one refinement of the invention, provision can be made for the fluid outlet channels to be arranged parallel to one another. The plurality of fluid outlet channels can, for example, form a fluid outlet channel row.

For example, a plurality of fluid outlet channel rows can be assigned to one application fluid channel. The plurality of fluid outlet channel rows can be arranged, in particular, parallel to the main direction of extent of the application unit. The fluid outlet channels of the plurality of fluid outlet channel rows extend between the application fluid channel and the application side of the application unit.

It can be advantageous if the fluid outlet channels of a first fluid outlet channel row and the fluid outlet channels of at least one further fluid outlet channel row are arranged offset with respect to one another. The fluid outlet channels of a first fluid outlet channel row and the fluid outlet channels of at least one further fluid outlet channel row can be arranged alternatingly along the main direction of extent of the application unit.

In particular, two fluid outlet channel rows are assigned to one application fluid channel. The two fluid outlet channel rows are preferably arranged parallel to the main direction of extent of the application unit. It can be favorable if the fluid outlet channels of the first fluid outlet channel row and the fluid outlet channels of the second fluid outlet channel row are arranged in alternating succession, in particular in a zigzag pattern.

In one refinement of the invention, provision can be made for the plurality of fluid outlet channels to be arranged linearly one after the other parallel to the main direction of extent of the application unit.

It can be favorable if the fluid outlet channel row is arranged directly below the application fluid channel. In particular, the inlet openings and outlet openings of the fluid outlet channels can be arranged in each case linearly one after the other parallel to the main direction of extent of the application unit. For example, the plurality of inlet openings and the plurality of outlet openings of the fluid outlet channels can form an outlet opening row and an inlet opening row.

It can be advantageous if the inlet opening row is arranged parallel to the main direction of extent of the application unit along the application fluid channel. As an alternative or in addition thereto, provision can be made for the outlet opening row to be arranged parallel to the main direction of extent of the application unit on the application side of the application unit.

The inlet opening row and the outlet opening row are preferably arranged directly one below the other or one above the other. As an alternative to this, provision can be made for the inlet opening row and the outlet opening row to be arranged offset with respect to one another, one below the other or one above the other.

In one refinement, provision can be made for the one closure unit to be able to selectively enable or close the one fluid outlet channel. Preferably, in each case one closure unit is assigned to exactly one fluid outlet channel. In particular, a nozzle can be enabled or closed by means of a closure unit. In particular, a nozzle can be opened or closed by means of a closure unit.

Furthermore, provision can be made for a plurality of fluid outlet channels to be able to be enabled or closed by means of a closure unit. In particular, provision can be made for the one closure unit to extend over a plurality of fluid outlet channels. It can be favorable if the closure unit opens or closes a plurality of fluid outlet channels simultaneously.

Preferably, each application unit comprises a main body. It can be favorable if the main body comprises at least one application plate body, at least one center plate body and at least one base plate body.

It can be advantageous if the main body is a cuboid. In particular, the cuboid has a square base surface. The cuboid extends along the main direction of extent of the application unit.

It can be favorable if an upper side of the main body is a contact-making side. An underside of the main body is, in particular, the application side. In particular, the main body preferably has four side surfaces. In particular, the two side surfaces which are arranged on the short side of the rectangular base surface are end faces.

The main body can, in particular, be formed in one piece. In contrast, it can be advantageous if the main body is of multi-part design. In particular, the main body can comprise at least two plate bodies. It can be favorable if the main body comprises three plate bodies. Furthermore, provision can be made for the main body to comprise a multiplicity of plate bodies.

Provision can be made for a plate body to be of cuboid form. A plurality of plate bodies are preferably of cuboid form. In particular, each plate body is of cuboid form.

Preferably, three or more than three plate bodies form the main body of the application unit.

The base plate body, the center plate body and the application plate body preferably each have a rectangular base surface. Each plate body has an upper side, an underside, two short side surfaces and two long side surfaces. The two short side faces are, in particular, two end faces of the respective plate body.

In one refinement, provision can be made for a first plate body to be, in particular, the application plate body. It can be advantageous if the application plate body extends along the main direction of extent of the application unit. The application plate body can have an upper side and an underside. In particular, the underside of the application plate body is the application side of the main body of the application unit.

Preferably, a further plate body is the center plate body. The center plate body preferably extends along the main direction of extent of the application unit.

The center plate body preferably has an upper side and an underside. It can be advantageous if a base surface of the center plate body and a base surface of the application plate body are at least approximately identical. The underside of the center plate body is arranged, in particular, on the upper side of the application plate body. In particular, the center plate body is arranged on the application plate body. The center plate body is preferably arranged between the application plate body and the base plate body.

It can be favorable if a further plate body is the base plate body. The base plate body preferably extends along the main direction of extent of the application unit.

The base plate body can have an upper side and an underside. It can be advantageous if the upper side of the base plate body is or forms the contact-making side of the base body of the application unit. It can be advantageous if a base surface of the base plate body and a base surface of the center plate body are at least approximately identical. The underside of the base plate body is arranged, in particular, on the upper side of the center plate body. In particular, the base plate body is arranged on the center plate body.

In one refinement, provision can be made for the base plate body, the center plate body and the application plate body to each have different plate thicknesses. In particular, the application plate body has the smallest thickness of the three plate bodies. In particular, the base plate body has the highest thickness of the three plate bodies. Provision can be made for the center plate body to be at least approximately twice as thick as the application plate body. In particular, the base plate body can be at least approximately twice as thick as the center plate body.

The plate bodies preferably form a plate body stack. The plate body stack forms, in particular, the main body of the application unit.

Provision can be made for two end faces of the base plate body, two end faces of the center plate body and two end faces of the application plate body to form the two end faces of the main body of the application unit overall.

It can be advantageous if the one end face of the main body is arranged on at least one fixing element. The second end face is preferably arranged on a second fixing element. In particular, the application unit is arranged between the two fixing elements. In particular, the plate body stack is arranged between the two fixing elements.

In one refinement, provision can be made for the plurality of application units to be arranged between the two fixing elements. In particular, a plurality of plate body stacks can be arranged between the two fixing elements.

Optionally, two further fixing elements can additionally be arranged on the at least one application unit. The two further fixing elements can preferably be arranged on the two long side surfaces of the main body. In particular, the fixing elements can form a frame around the application unit. In particular, the plurality of application units can be surrounded by a frame-like arrangement of the fixing elements.

The plurality of application units can be arranged parallel to one another, for example. The plurality of application units can, in particular, be arranged directly adjacently to one another. Alternatively, the plurality of application units can be arranged at a distance from one another. It can be favorable if the plurality of application units are arranged parallel to one another. Preferably, the plurality of application units are arranged at an oblique angle between the two fixing elements. The angle between the main direction of extent of the application units and the at least one fixing element is preferably less than 90 degrees.

In particular, the fluid outlet channel row is arranged at an oblique angle between the two fixing elements. Preferably, the angle between the main direction of extent of the application unit and the at least one fixing element is less than 90 degrees, for example less than 30°, in particular less than 20°. In particular, the application unit is not arranged perpendicularly with respect to the at least one fixing element. It can be advantageous if the angle between the fluid outlet channel row and the at least one fixing element is less than 90 degrees, for example less than 30°, in particular less than 20°. It can be advantageous if the plurality of fluid outlet channel rows are arranged parallel to one another and are arranged obliquely with respect to the at least one fixing element.

The plurality of fluid outlet channel rows are preferably arranged in the application device in a matrix-like manner, such that a minimum spacing of the nozzles from one another in each case in one application unit and also between the plurality of application units can be ensured.

Preferably, at least one actuating fluid channel extends parallel to the main direction of extent of the application unit in the application plate body and the center plate body. In particular, the actuating fluid channel is formed by the application plate body and the center plate body.

It can be favorable if the actuating fluid channel extends over the entire main body parallel to the main direction of extent of the application unit. The actuating fluid channel preferably extends from one end face of the main body as far as the opposite end face of the main body.

The actuating fluid channel can be of cylindrical form. The actuating fluid channel can, in particular, have a circular cross section. Alternatively, the cross section of the actuating fluid channel can be polygonal or can have any conceivable geometric shape.

In one refinement, provision can be made for the actuating fluid channel to be formed by a recess in the center plate body and by a corresponding recess in the application plate body. The recesses can be round. The recesses can likewise be angular. The cross section of the recess in the center plate body can be, in particular, semicircular. In addition to this, the cross section of the recess in the application plate body can likewise be semicircular. It can be favorable if the respective cross sections of the recesses in the center plate body and the application plate body together form the circular cross section of the actuating fluid channel. As an alternative to this, the respective cross sections of the recesses in the center plate body and the application plate body can together form any conceivable cross section of the actuating fluid channel.

It can be favorable if the recesses in the application plate body and the center plate body extend parallel to the main direction of extent of the application unit. In particular, the recess in the application plate body extends parallel to the main direction of extent of the application unit. The recess in the center plate body preferably extends parallel to the main direction of extent of the application unit.

It can be advantageous if the recesses of the center plate body and of the application plate body extend over the entire main body parallel to the main direction of extent. The recesses preferably extend from one end face of the main body as far as the opposite end face of the main body. As an alternative to this, provision can be made for the recesses not to extend over the entire main body parallel to the main direction of extent.

The actuating fluid channel is preferably arranged between the valve unit and an underside of the application unit. The actuating fluid channel can be arranged between the valve unit and the application side of the main body. In particular, the actuating fluid channel can be arranged directly below the valve unit. As an alternative to this, provision can be made for the actuating fluid channel to be arranged next to the valve unit.

In one refinement, provision can be made for the valve units to be arranged along the actuating fluid channel. In particular, the valve units are arranged below or next to the actuating fluid channel along the main direction of extent of the application unit.

The actuating fluid channel is preferably a compressed air channel for supplying compressed air to the closure unit.

Furthermore, it can be advantageous if a further actuating fluid channel extends parallel to the main direction of extent of the application unit in the at least one base plate body. For example, the further actuating fluid channel is a second one of two actuating fluid channels.

For example, the further actuating fluid channel extends parallel to the main direction of extent of the application unit over the entire main body. In particular, the further actuating fluid channel extends from one end face of the main body as far as the opposite end face of the main body.

The further actuating fluid channel can be of cylindrical form. The further actuating fluid channel can, in particular, have a circular cross section. The cross section of the further actuating fluid channel can have any geometric shape.

It can be favorable if the further actuating fluid channel extends parallel to the main direction of extent of the application unit. It can be advantageous if the actuating fluid channel extends over the entire main body parallel to the main direction of extent of the application unit. For example, the further actuating fluid channel extends from one end face of the main body as far as the opposite end face of the main body. In particular, the further actuating fluid channel can extend from one end face of the base plate body as far as the opposite end face of the base plate body. As an alternative to this, provision can be made for the further actuating fluid channel not to extend over the entire main body parallel to the main direction of extent.

In particular, the further actuating fluid channel can be a through bore. The through bore can extend in the main body parallel to the main direction of extent of the application unit. The through bore can extend, in particular, in the base plate body parallel to the main direction of extent of the application unit.

For example, the further actuating fluid channel can be in the form of an insert. In particular, the insert can be a cylindrical hollow body.

It can be favorable if the further actuating fluid channel is arranged between the application fluid channel and an upper side of the application unit. The further actuating fluid channel can preferably be arranged between the application fluid channel and the contact-making side of the main body. For example, the actuating fluid channel can be arranged directly above the application fluid channel. In particular, the further actuating fluid channel extends directly above the application fluid channel parallel to the main direction of extent of the application unit.

Alternatively, the further actuating fluid channel can be arranged above or next to the actuating fluid channel. The actuating fluid channel is preferably arranged directly above the application side in the main body. The further actuating fluid channel can be arranged, in particular, directly below the contact-making side in the main body. For example, the actuating fluid channel and the further actuating fluid channel are arranged on two opposite sides in the main body.

The actuating fluid channel is preferably a vacuum channel for discharging the compressed air from the closure unit.

It can be favorable if the application unit comprises at least one actuating fluid channel. The application unit preferably comprises at least two actuating fluid channels.

The at least one actuating fluid channel can be assigned to at least one valve unit. In one refinement, provision can be made for the at least one actuating fluid channel to be assigned to a plurality of valve units of the application unit for supplying actuating fluid. It can be advantageous if the further actuating fluid channel is assigned to a plurality of valve units of the application unit for discharging actuating fluid. In particular, the compressed-air channel can be assigned to a plurality of valve units of the application unit. In addition to this, the vacuum channel can be assigned to a plurality of valve units of the application unit.

The actuating fluid can, in particular, be a gas or a liquid.

In one refinement, provision can be made for the application unit not to comprise any further actuating fluid channel. Preferably, the further actuating fluid channel can be replaced by means of a plurality of ventilation channels. For example, each valve unit can comprise a ventilation channel. The ventilation channels can be arranged obliquely with respect to the main direction of extent of the main body. In particular, the ventilation channels extend at least approximately perpendicularly with respect to the main direction of extent of the application unit. The ventilation channels extend, in particular, from the valve unit to the contact-making side of the application unit.

The application fluid channel can run within the center plate body and the base plate body. The application fluid channel is preferably formed by the center plate body and the base plate body.

It can be advantageous if the application fluid channel extends over the entire main body parallel to the main direction of extent of the application unit. For example, the application fluid channel extends from one end face of the main body as far as the opposite end face of the main body.

The application fluid channel can be of cylindrical form. The application fluid channel can preferably have a circular cross section. The cross section of the application fluid channel can have any conceivable geometric shape.

The application fluid channel is formed, for example, by a recess in the center plate body and by a corresponding recess in the base plate body. The recesses can be round. The recesses can be angular. The cross section of the recess in the center plate body can, in particular, differ from the cross section of the recess in the base plate body. As an alternative to this, provision can be made for the cross sections of the recesses in the base plate body and the center plate body to be identical. The cross sections of the recesses in the center plate body and the base plate body together form the cross section of the application fluid channel.

The respective recesses in the center plate body and the base plate body preferably extend parallel to the main direction of extent of the application unit. For example, the recesses of the center plate body and of the base plate body extend over the entire main body parallel to the main direction of extent. The recesses extend, in particular, from one end face of the main body as far as the opposite end face of the main body.

In one refinement, provision can be made for the respective recesses to be arranged in the center plate body and in the base plate body in such a way that, in the assembled state, they lie opposite one another and form the application fluid channel.

It can be favorable if the at least one valve unit extends or the plurality of valve units extend transversely with respect to the main direction of extent of the application unit. The at least one valve unit or the plurality of valve units preferably extends/extend transversely with respect to the main direction of extent of the application unit in the center plate body and the base plate body. In particular, the at least one valve unit extends or the plurality of valve units extend at least approximately perpendicularly with respect to the main direction of extent of the application unit. For example, the at least one valve unit extends or the plurality of valve units extend at least approximately perpendicularly with respect to a plane, in which the plate bodies are arranged so as to adjoin one another.

In one refinement, provision can be made for the valve unit to extend over the entire base plate body at least approximately perpendicularly with respect to the main direction of extent. In addition, the valve unit can extend at least approximately perpendicularly with respect to the main direction of extent in the center plate body. In particular, the valve unit extends perpendicularly with respect to the main direction of extent at least approximately over half of the center plate body.

It can be advantageous if the at least one valve unit comprises a valve for actuating the closure unit. The valve unit fluidically connected to the at least one actuating fluid channel. The valve unit can, in particular, be fluidically connected to the compressed-air channel. The valve unit allows actuating fluid to be supplied to the at least one closure unit. By means of the valve unit, the compressed air can be forwarded from the compressed-air channel to the at least one closure unit.

In one refinement, provision can be made for the at least one closure unit to comprise at least one closure element and at least one guide element.

The closure element is preferably of sleeve-like design. The at least one closure element can be a rubber cuff, which is preferably deformable. The rubber cuff can, in particular, comprise a boot. The rubber cuff can, in particular, be a flexible sleeve.

Provision can furthermore be made for the application fluid to be able to be supplied to at least one outlet opening through an interior space of the closure unit, in particular of the closure element. The respective outlet opening can be formed by means of the closure unit and/or the main body of the application unit.

The interior space of the at least one closure element can be shaped as a cylinder which has a diameter of approximately 0.5 mm to approximately 1 mm. The cylinder preferably has a diameter of approximately 0.7 mm to approximately 0.9 mm.

Alternatively, the cylinder can have a diameter of greater than approximately 1 mm to approximately 4 mm. The cylinder preferably has a diameter of approximately 2 mm to approximately 3 mm.

The cylinder can preferably have a circular base surface. Alternatively, the cylinder can have an oval base surface, for example in the form of an ellipse.

The base surface and the diameter can preferably relate to an initial state, that is to say an undeformed state, of the at least one closure element.

Additionally or alternatively, the at least one closure element can have one or more predetermined deformation portions.

The one predetermined deformation portion or the plurality of predetermined deformation portions can preferably be cross-sectional portions, in which the at least one closure element is thinner within a respective sectional plane than in the remaining cross-sectional portions within the respective sectional plane. An elliptical hollow cross section can, for example, meet such conditions.

The at least one closure element can preferably have two predetermined deformation portions which lie diametrically opposite one another in relation to a central axis of the closure element.

In one refinement, provision can be made for the closure element to have varying material thicknesses, for example in order to enable a preferred direction during the deformation of the closure element and/or a predefined deformation geometry. The closure element preferably comprises at least one stabilizing region and at least one folding region. It can be favorable if the closure element comprises two folding regions and two stabilizing regions. The two stabilizing regions can be pressed together, in particular. In the two folding regions, the closure element can preferably be folded and/or folded in itself. It can be advantageous if the pressing together of the two stabilizing regions and the folding of the two folding regions makes it possible to close the fluid outlet channel.

The material thickness of the closure element in the at least one stabilizing region can, for example, be greater than a material thickness in the at least one folding region. In particular, it can be favorable if the closure element has an at least approximately circular outer diameter and an at least approximately elliptical inner diameter. As an alternative thereto, provision can be made for the closure element to have an at least approximately elliptical outer diameter and an at least approximately circular inner diameter.

For example, the at least one closure element is formed from an elastomer. The elastomer can be, for example, natural rubber, EPDM, PUR, neoprene, NBR (nitrile butadiene rubber) and/or silicone.

The at least one guide element can surround the closure element. The guide element can, in particular, be a support sleeve. The support sleeve can be formed, for example, in the manner of a net. It can be favorable if the support sleeve has one or more holes, in particular for the entry and exit of actuating fluid into/from a pressure space which surrounds the at least one guide element and/or the at least one closure element on the peripheral side.

As an alternative or in addition thereto, provision can be made for the guide element to comprise and/or be formed from two half shells. In particular, the two half shells can be arranged on the closure element and/or surround the closure element as a right-side and a left-side half shell. It can be favorable if the two half shells have one or more holes, in particular for the entry and exit of actuating fluid into/from the pressure space.

Provision can be made for the guide element to have a higher rigidity than the closure element. In particular, the guide element is inherently rigid during normal operation of the application device.

It can be advantageous if the closure element is fixed or fixable in a cavity of the main body of the application unit by means of the guide element. For example, the guide element can be arranged, in particular clamped in, between ends of the closure element facing away from one another, in particular in order to fix the ends of the closure element facing away from one another locally in the cavity of the main body of the application unit. In particular, a distance between the ends of the closure element facing away from one another can be kept at least approximately constant by means of the guide element during a deformation of the closure element in a central region or closure region thereof.

It can be advantageous if a sealing bead, in particular an annular sealing bead, is formed in each case at the ends of the closure element facing away from one another. The guide element can be arranged, in particular clamped in, between the two sealing beads. In particular, the guide element serves for fixing and positioning the sealing beads in the cavity and/or for pressing the sealing beads against walls of the cavity, such that the actuating fluid cannot escape from the cavity of the main body of the application unit during the deformation of the closure element. For example, the guide element can be referred to as a positioning element.

It can be favorable if the guide element counteracts widening of the closure element and/or prevents uncontrolled widening of the closure element.

It can be advantageous if the at least one closure unit extends or the plurality of closure units extend transversely with respect to the main direction of extent of the application unit in the center plate body and the application plate body. The at least one closure unit or the plurality of closure units preferably extends/extend at least approximately perpendicularly with respect to the main direction of extent of the application unit.

The one closure unit or the plurality of closure units can be arranged directly below the application fluid channel in the main body.

In one refinement, provision can be made for the closure unit to be arranged between the inlet opening and the outlet opening of the fluid outlet channel. The plurality of closure units are preferably arranged between the respective outlet opening and inlet opening of the fluid outlet channel.

The main body of the application unit preferably comprises at least one cavity. The cavity can be arranged, for example, directly below the application fluid channel. The at least one closure unit can be arranged in the at least one cavity.

It can be favorable if a pressure space extends in the cavity between the closure unit and the main body.

The cavity can be arranged transversely with respect to the main direction of extent of the application unit. In particular, the cavity is arranged at least approximately perpendicularly with respect to the main direction of extent of the application unit.

The cavity is preferably of cylindrical form. The cavity can also be of spherical or cuboid form. It can be advantageous if the cavity is formed by the application plate body and the center plate body. The cavity is preferably formed by a recess in the center plate body and by a corresponding recess in the application plate body. The recesses can, in particular, be round. Alternatively, the recesses can be angular. The respective recesses in the application plate body and the center plate body can be arranged in the application plate body and in the center plate body in such a way that, in an assembled state of the center plate body and of the application plate body, they lie opposite one another and thus form the cavity.

The main body of the application unit can preferably comprise a plurality of cavities. It can be advantageous if a cavity is assigned to each fluid outlet channel. Alternatively, provision can be made for a cavity to comprise a plurality of fluid outlet channels. The cavities can be arranged in linear succession parallel to the main direction of extent of the application unit and thus form a cavity row.

In one refinement, provision can be made for the closure element to be received in a force-fitting manner in the cavity. As an alternative to this, the closure element can be received in a form-fitting manner in the cavity.

It can be advantageous if the at least one fluid outlet channel extends in the cavity transversely with respect to the main direction of extent of the application unit. In particular, a cylindrical interior space of the closure element can extend perpendicularly with respect to the main direction of extent of the application unit. The interior space of the closure element preferably forms a part of the fluid outlet channel. In particular, the interior space of the closure element forms the fluid outlet channel.

It can be favorable if the plurality of closure units are connected to a common actuating fluid channel by means of a plurality of connecting channels, wherein a fluid connection between the actuating fluid channel and the respective closure unit can preferably be established or interrupted by means of the valve unit assigned to a respective closure unit.

The connecting channel can preferably be arranged between the closure unit and the valve unit. For example, the connecting channel connects the cavity to the valve unit. The connecting channel ensures rapid supply of actuating fluid to the closure unit. In particular, the connecting channel guides the compressed air into the cavity.

In one refinement, provision can be made for the connecting channel to extend transversely with respect to the main direction of extent of the application unit. The connecting channel preferably extends transversely with respect to the main direction of extent of the application unit in the center plate body. It can be advantageous if the connecting channel is arranged at an angle of less than 90 degrees with respect to the main direction of extent of the application unit. In particular, the connecting channel and the fluid outlet channel form an angle of at least approximately 45 degrees.

It can be favorable if the at least one closure element is of elastic form and is deformable in a pressure-dependent manner. The closure element can be surrounded by actuating fluid in a state of use of the application unit. For example, the closure element can be deformed by an increasing and decreasing pressure of the actuating fluid in the cavity of the main body. Preferably, the closure element can selectively enable or close the associated fluid outlet channel by varying the prevailing pressure of the actuating fluid in the cavity of the main body. It can be advantageous if the closure element closes the associated fluid outlet channel when overpressure is present. As an alternative to this, provision can be made for the closure element to open the associated fluid outlet channel during pressure reduction. In particular, rapid and controlled opening of the fluid outlet channel can be promoted by an additional vacuum.

For example, a cross-sectional area of the outlet opening can be reversibly increased or reduced by deformation of the closure element. Accordingly, the cross-sectional area of the outlet opening can be the smallest when the overpressure of the actuating fluid is present in the cavity of the main body. The cross-sectional area can be at least approximately zero. The fluid outlet channel is, in particular, open and the application fluid can leave the application unit. The cross-sectional area of the outlet opening can be increased during pressure reduction, in particular under an applied vacuum. The fluid outlet channel is, in particular, closed and the application fluid cannot leave the application unit.

Furthermore, it can be favorable if the plurality of valve units are arranged in linear succession parallel to the main direction of extent of the application unit and thereby form a valve unit row. It can likewise be favorable if the plurality of closure units are arranged in linear succession parallel to the main direction of extent of the application unit and thereby form a closure unit row. The valve unit row and the closure unit row are preferably arranged so as to run parallel to one another.

It can be advantageous if the closure units comprise or are pinch valves.

Additionally or alternatively, the valve units can comprise or can be angle seat valves.

Additionally or alternatively, the valve units can comprise or can be pilot valves.

In one refinement, provision can be made for the valve units to comprise or to be electric valves.

The electric valves can preferably comprise or be solenoid valves.

Additionally or alternatively, the electric valves can comprise or be piezo valves.

Additionally or alternatively, the electric valves can comprise or be servo-controlled or electromechanically controlled valves.

The application unit can preferably comprise an application fluid circuit or form a constituent part thereof, such that a permanent flow of the application fluid can be maintained in the application fluid channel. In particular, application fluid flows permanently through the application fluid channel in a state of use.

The application fluid channel preferably has an at least approximately constant cross section, as a result of which, in the state of use, preferably little or no turbulence of the application fluid arises in the application fluid channel. In particular, the permanent flow of the application fluid is approximately a permanent laminar flow.

Alternatively, a permanent turbulent flow can also be provided in the application fluid channel. This can contribute, in particular, to the avoidance of sediment formation in the application fluid channel.

It can be advantageous for application fluid to bear against the inlet openings of the fluid outlet channels at all times owing to the permanent flow through the application fluid channel. In particular, the application fluid can be permanently released from each fluid outlet channel of the application unit.

The present invention further relates to a method for applying a fluid by means of an application device.

The present invention is based on the object of providing an application device for applying application fluid, which application device can be installed easily and quickly and can be produced at low cost. In addition, the present invention is based on the object of providing an application device which can be operated without wear, with little maintenance and with little installation.

This object is achieved according to the invention by the features of claim 15.

The method according to the invention preferably has individual, or multiple, features and/or advantages described in conjunction with the application device according to the invention.

It can be advantageous if the application fluid is applied in the form of drops. The application fluid emerges, in particular, from at least one fluid outlet channel and is applied by gravity to an object arranged directly underneath.

The object can be, for example, a sand bed.

It can be favorable if a plurality of closure units selectively enable or close the plurality of fluid outlet channels. Preferably, the one valve unit actuates or the plurality of valve units actuate the plurality of closure units. In particular, the fluid outlet channels are enabled or closed by the actuation of the closure units.

The closure units are preferably actuated pneumatically or hydraulically.

It can be advantageous if an actuating fluid flows permanently through at least one actuating fluid channel. The actuating fluid can, in particular, be a gas or a liquid. In the at least one actuating fluid channel, there is preferably permanently an overpressure. For example, a permanent gas overpressure prevails in the actuating fluid channel. The actuating fluid channel can, in particular, be a compressed-air channel. As an alternative to this, a permanent liquid overpressure can prevail in the actuating fluid channel.

Preferably, the overpressure of the actuating fluid permanently prevails at the at least one valve unit. It can be favorable if the same overpressure of the actuating fluid prevails at each valve unit. In particular, the overpressure prevailing in the actuating fluid channel corresponds to the overpressure prevailing at the plurality of valve units of the application unit.

In one refinement, provision can be made for the valve unit to comprise a valve, preferably electric valve, which is activated or actuated by means of electrical control pulses. The electrical control pulses preferably trigger the movement of a piston, which can, in particular, assume an enable position. In the enable position, for example, the actuating fluid can be supplied to the closure unit. The actuating fluid can accordingly flow into a cavity of the main body, in which the at least one closure unit is arranged. The at least one valve unit can accordingly actuate or activate the closure unit indirectly, that is to say by means of establishing or interrupting the fluid connection to the actuation channel and/or the further actuation channel.

In addition or as an alternative, provision can be made for the at least one valve unit to be able to directly actuate or activate the closure unit assigned to it in each case. The direct actuation or activation can take place, for example, in the form of a direct mechanical actuation or activation.

The at least one valve unit can be electrically controlled, for example, with a minimum opening frequency of at least approximately 1 Hz, preferably approximately 5 Hz, preferably approximately 10 Hz (Hertz). In addition or alternatively, the at least one valve unit can be electrically controlled, for example, with a maximum opening frequency of approximately 100 Hz, preferably approximately 50 Hz, preferably approximately 30 Hz (Hertz).

The opening frequency can advantageously be understood to mean that it indicates the number of electrical control pulses per second, i.e. how often the at least one valve unit changes per second from a closed position into an open position and vice versa.

A respective electrical control pulse can have, for example, a minimum pulse length of at least approximately 5 ms, preferably approximately 10 ms, preferably approximately 20 ms (milliseconds). Additionally or alternatively, a respective electrical control pulse can have, for example, a pulse length of at most approximately 100 ms, preferably approximately 50 ms, preferably approximately 40 ms (milliseconds). The pulse length can preferably be constant.

In the enable position, the actuating fluid preferably flows through the valve into an adjacent connecting channel. The connecting channel can, in particular, fluidically connect the valve unit to the closure unit. It can be advantageous if the connecting channel connects the valve unit to the cavity of the main body.

In one refinement, provision can be made for a plurality of valves to be actuated simultaneously or alternately by means of a short electrical pulse. For example, each valve can be actuated individually and independently of the further valves. Each piston of each valve can assume an enable position independently of the further valves. Preferably, each valve is actuated individually.

It can be favorable if, in the enable position, the overpressure of the actuating fluid prevailing at the closure units corresponds to the overpressure in the actuating fluid channel. Preferably, pressure equalization takes place between the actuating fluid channel and the cavity of the main body. As a result, an overpressure can be generated in the cavity of the main body. For example, the inflowing actuating fluid can cause an overpressure to arise in the respective cavities of the main body. In particular, there is an overpressure in the respective cavities only when the associated valve is in the enable position.

The overpressure preferably causes a deformation of an elastic closure element. For example, a cross-sectional area of the fluid outlet channel is reduced and/or increased by deformation of the closure element.

In particular, the fluid outlet channel is formed by an interior space of the closure element. The application fluid preferably flows through the interior space of the closure element. The interior space of the closure element can be of cylindrical form. In particular, the interior space of the closure element is a circular cylinder.

For example, the diameter of the closure element is reduced by the surrounding overpressure of the actuating fluid in such a way that a throughflow of the application fluid in the interior of the closure element can be prevented. For example, the plurality of fluid outlet channels can be closed individually or jointly. The fluid outlet channel can be closed as long as sufficient overpressure for deforming the closure element is present in the cavity.

As an alternative to this, the overpressure of the actuating fluid in the cavity of the main body can be reduced in order to open the fluid outlet channel again. By reducing the overpressure, the deformed closure element can assume at least approximately its original shape, for example. Preferably, the original diameter of the closure element can be at least approximately restored.

Preferably, the valve unit is actuated again by means of a short electrical pulse. It can be advantageous if each valve unit can be actuated individually. The electrical pulse can trigger a renewed movement of the piston. The piston of the valve unit can assume a return position, for example. In the return position, the piston can fluidically connect the connecting channel to a further actuating fluid channel.

The further actuating fluid channel can preferably be a vacuum channel.

It can be advantageous if the further actuating fluid channel can reduce the overpressure in the cavity of the main body. In order to reduce the overpressure, the vacuum channel can preferably be fluidically connected to the cavity via the valve unit. It can be favorable if the fluid outlet channel again has a uniform cross section owing to the pressure reduction in the cavity. The fluid outlet channel can, in particular, be open. For example, the plurality of fluid outlet channels can be open individually or jointly.

As explained above, a fluid connection between the actuating fluid channel and the respective closure unit can preferably be established or interrupted by means of the one valve unit or the plurality of valve units (which is/are each assigned to a respective closure unit or the respective closure units).

According to this indirect type of control or the actuation of the closure unit, the plurality of valve units are preferably designed as pilot valves.

A respective pilot valve can accordingly be understood to mean that it can be configured as a pilot valve unit, such that it establishes a fluid connection between the actuating fluid channel and the closure unit in an open position. The pressurized fluid, preferably compressed air, can accordingly actuate, preferably close, the closure element of the closure unit. The open position can relate, in particular, to an open position with respect to the actuating fluid channel.

Accordingly, in a closed position, the pilot valve can disconnect a fluid connection between the actuating fluid channel and the closure unit. The closed position can relate, in particular, to a closed position with respect to the actuating fluid channel.

Furthermore, by means of the one valve unit or the plurality of valve units (which is/are assigned to a respective closure unit or the respective closure units), a fluid connection between the further actuating fluid channel and the respective closure unit can preferably be established or interrupted.

In the open position (with respect to the actuating fluid channel), the respective pilot valve can interrupt a fluid connection between the further actuating fluid channel and the closure unit.

Accordingly, in the closed position (with respect to the actuating fluid channel), the pilot valve can establish a fluid connection between the further actuating fluid channel and the closure unit. As explained above, the further actuating fluid channel can have a negative pressure and can preferably be designed as a vacuum channel.

The pressurized fluid, preferably compressed air, can accordingly be conducted from the closure unit into the further actuating channel by means of the valve unit. In this way, the closure unit can be vented and actuated, preferably opened, in this way.

The function of the at least one valve unit, which is preferably designed as a pilot valve, can consequently be understood to mean that it actuates or controls the closure unit indirectly, that is to say by means of the respective establishment or interruption of the fluid connection to the actuating channel and/or the further actuating channel.

In addition or alternatively, provision can be made for the at least one valve unit to be able to directly actuate the closure unit assigned to it in each case. In this case, the devices which ensure the fluid supply, such as, for example, the actuating fluid channel, the further actuating fluid channel and the connecting channels, can be omitted.

In the case of direct actuation, the one valve unit or the plurality of valve units can each comprise or can be solenoid valves and/or piezo valves.

The direct actuation can preferably take place on one side on the closure element. Alternatively, the direct actuation can take place on multiple sides, preferably on two sides, and symmetrically on the closure element.

Here, an actuating direction can be oriented, in particular, perpendicularly with respect to a central axis of the closure element.

In addition, the solenoid valves and/or piezo valves can comprise at least one mechanical actuating element for direct actuation of the closure element.

The mechanical actuating element can be formed, for example, as an actuating ring or as an actuating half shell.

The guide element can preferably have one or more passage openings, through which the mechanical actuating element arranged therein in the mounted state can be actuated by the respective valve unit, for example by means of an actuating rod.

In the case of one-sided actuation, the guide element can have an inner support surface.

The mechanical actuating element can press the closure element against the inner support surface and thus, owing to its elastic properties, can open and close the fluid outlet channel in a controllable manner.

In the compressed state, a cross section of the closure element can have an oval cross section, at least in the region of action of the mechanical actuating element.

In the case of a multiple-sided, preferably two-sided, actuation, the closure element can be actuated axially symmetrically and transversely with respect to its central axis by means of two mechanical actuating elements, preferably two actuating half shells.

If two mechanical actuating elements are provided, they can be actuated by means of a common valve unit. Alternatively, each of the mechanical actuating elements can be assigned a valve unit for the actuation thereof.

In the non-actuated or open state, the two mechanical actuating elements can advantageously assume the function of the guide element, such that the latter can be dispensed with.

Alternatively, the guide element can be provided in addition to the two mechanical actuating elements and can correspondingly have two passage openings for the passage of the two mechanical actuating elements.

Further preferred features and/or advantages of the invention are the subject matter of the description hereunder and of the graphic illustration of exemplary embodiments.

### BRIEF DESCRIPTION OF THE DRAWINGS

FIG. 1 shows a schematic perspective illustration of the application device, wherein the application device comprises a plurality of application units and a plurality of fixing elements.

FIG. 2 shows a schematic perspective illustration of the application unit of an application device, wherein a main body comprises a base plate body, a center plate body and an application plate body.

FIG. 3 shows a schematic perspective illustration of the application unit of an application device, wherein the application unit is shown, in particular, on the application side.

FIG. 4 shows a schematic perspective illustration of the application unit of an application device from FIG. 2, wherein a base plate body has been removed.

FIG. 5 shows a schematic longitudinal section through the application unit from FIG. 2, wherein the plurality of fluid outlet channels and closure units are shown.

FIG. 6 shows a schematic longitudinal section through the application unit from FIG. 2, wherein the one actuating fluid channel and the plurality of valve units are shown.

FIG. 7 shows a schematic cross section through the application unit, wherein the application fluid channel, the valve unit, the two actuating fluid channels, the connecting channel, the feed channels and the closure unit are arranged in the main body.

Identical or functionally equivalent elements are provided with the same reference signs in all of the figures.

### DETAILED DESCRIPTION OF THE DRAWINGS

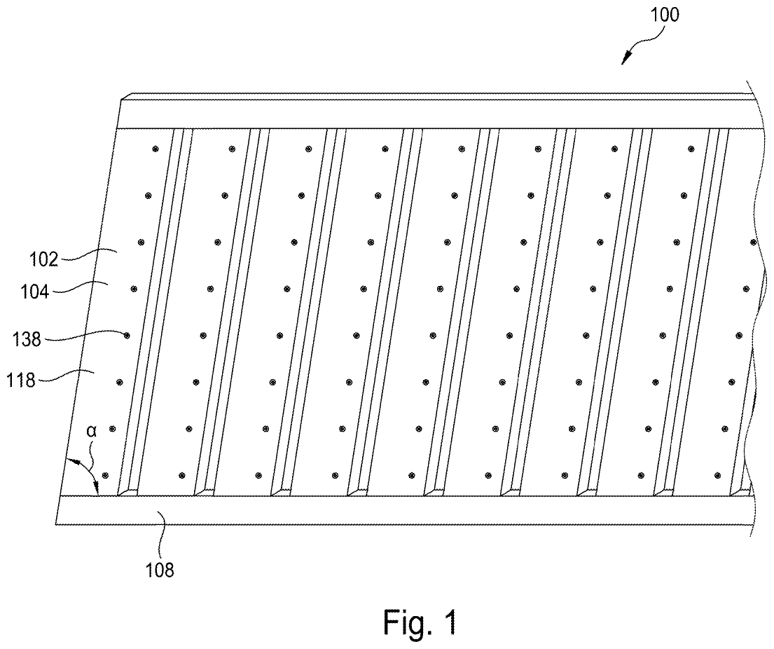

One embodiment of an application device designated as a whole by 100 shown in FIGS. 1 to 7 serves, for example, for applying application fluid to an object, in particular for applying cement paste to a sand bed.

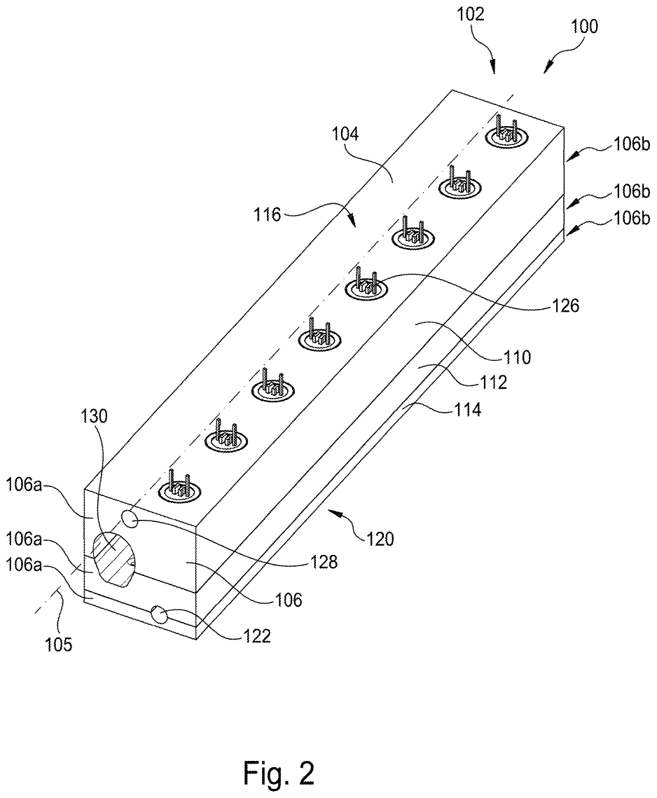

The application device 100 comprises a plurality of application units 102. Each application unit 102 comprises a main body 104. The main body 104 is a cuboid which extends along a main direction of extent 105 of the application unit 102. The main body 104 has two end faces 106. The two end faces 106 of the main body 104 are each arranged on a fixing element 108. FIGS. 1 and 2 show only one of the two end faces 106.

The application unit 102 is arranged between the two fixing elements 108. The plurality of application units 102 are arranged between the two fixing elements 108.

The plurality of application units 102 are arranged parallel to one another. The plurality of application units 102 are arranged spaced apart from one another. The plurality of application units 102 are arranged parallel to the main direction of extent 105 of the application unit 102. The plurality of application units 102 are arranged at an oblique angle α between the two fixing elements 108. The angle α between the main direction of extent 105 of the application unit 102 and the fixing element 108 is less than 90 degrees.

The main body 104 is of multi-part design. An application unit 102 shown in FIG. 2 comprises a base plate body 110, a center plate body 112 and an application plate body 114. The three plate bodies 110; 112; 114 together form the main body 104 of the application unit 102.

The base plate body 110, the center plate body 112 and the application plate body 114 each have a rectangular base surface. Each plate body 110; 112; 114 has two short side surfaces. The two short side faces of each plate body are the two end faces 106a; 106b of the respective plate body 110; 112; 114.

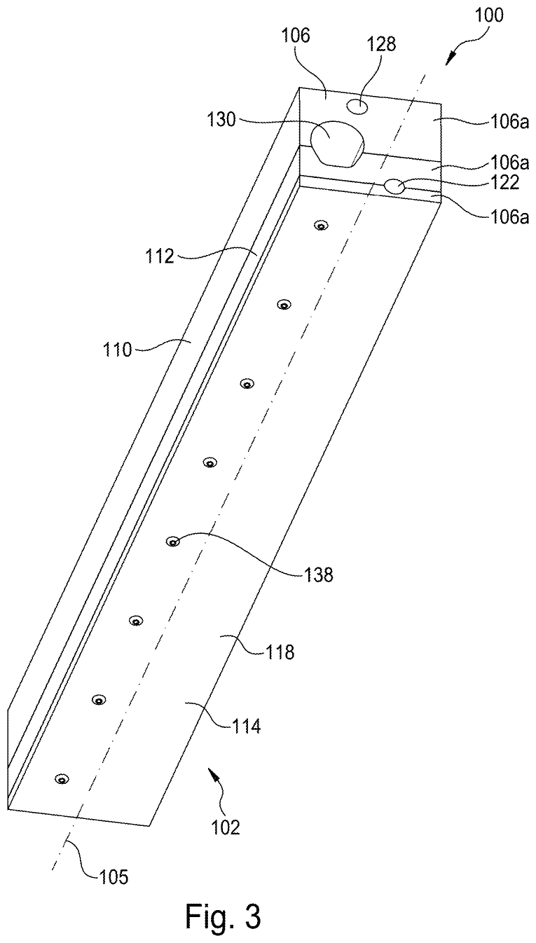

An upper side of the main body 104 is a contact-making side 116. An underside of the main body 104 is an application side 118. The application side 118 of the main body 104 is shown in FIG. 3.

The application plate body 114 extends along the main direction of extent 105 of the application unit 102. The application plate body 114 has an upper side and an underside. The underside of the application plate body 114 is the application side 118 of the main body 104 of the application unit 102.

The center plate body 112 extends along the main direction of extent 105 of the application unit 102. The center plate body 112 has an upper side and an underside. The center plate body 112 is arranged on the application plate body 114. The center plate body 112 is arranged between the application plate body 114 and the base plate body 110.

The base plate body 110 extends along the main direction of extent 105 of the application unit 102. The base plate body 110 has an upper side and an underside. The upper side of the base plate body 110 is the contact-making side 116 of the main body 104 of the application unit 102. The base surface of the base plate body 110, the base surface of the center plate body 112 and the base surface of the application plate body 114 are identical.

The base plate body 110, the center plate body 112 and the application plate body 114 each have different plate thicknesses. The application plate body 114 has the smallest thickness of the three plate bodies 110; 112; 114. The base plate body 110 has the highest thickness of the three plate bodies 110; 112; 114. The center plate body 112 is approximately twice as thick as the application plate body 114. The base plate body 110 is approximately twice as thick as the center plate body 112.

The plate bodies 110; 112; 114 form a plate body stack 120. The plate body stack 120 forms the main body 104 of the application unit 102. The two end faces 106a; 106b of the base plate body 110, the two end faces 106a; 106b of the center plate body 112 and the two end faces 106a; 106b of the application plate body 114 the two end faces 106 of the main body 104 of the application unit 102.

The actuating fluid channel 122 extends parallel to the main direction of extent 105 of the application unit 102 in the application plate body 114 and the center plate body 112. The actuating fluid channel 122 is formed by the application plate body 114 and the center plate body 112.

The actuating fluid channel 122 shown in FIGS. 2 to 7 extends parallel to the main direction of extent 105 of the application unit 102 over the entire main body 104. The actuating fluid channel 122 extends from one end face 106 of the main body 104 as far as the opposite end face 106 of the main body 104.

The actuating fluid channel 122 is of cylindrical form. The actuating fluid channel 122 has a circular cross-sectional area. The actuating fluid channel 122 is formed by a recess 124 in the center plate body 112 and by a corresponding recess 124 in the application plate body 114. The recesses 124 are shown, in particular, in FIG. 6. The recesses 124 are round. The cross-sectional area of the recesses 124 in the center plate body 112 and the application plate body 114 are semicircular and extend parallel to the main direction of extent 105 of the application unit 102 over the entire plate body. The cross-sectional areas of the recesses 124 in the center plate body 112 and the application plate body 114 together form the circular cross-sectional area of the actuating fluid channel 122.

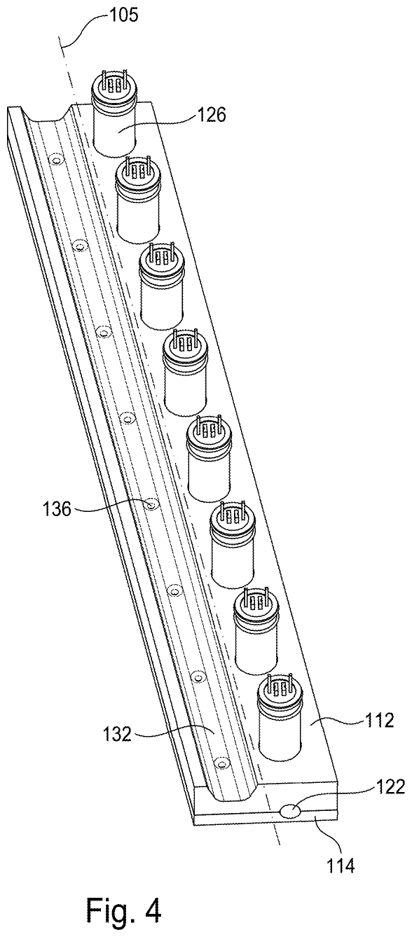

The actuating fluid channel 122 is arranged between a valve unit 126 and the application side 118 of the main body 104. As can be seen in FIGS. 4, 6 and 7, the actuating fluid channel 122 is arranged directly below the valve unit 126.

As shown in FIG. 2, the main body 104 of the application unit 102 has a nozzle-side region and a valve-side region. The nozzle-side region and the valve-side region subdivide the main body 104 of the application unit 102 into two regions of equal size which extend parallel to the main direction of extent 105 of the application unit 102.

A further actuating fluid channel 128 extends parallel to the main direction of extent 105 of the application unit 102 in the base plate body 110. The further actuating fluid channel 128 is a second of two actuating fluid channels 122; 128.

The further actuating fluid channel 128 extends parallel to the main direction of extent 105 of the application unit 102 over the entire main body 104. The further actuating fluid channel 128 extends from one end face 106 of the main body 104 as far as the opposite end face 106 of the main body 104. The further actuating fluid channel 128 extends from one end face 106a of the base plate body 110 as far as the opposite end face 106a of the base plate body 110.

The further actuating fluid channel 128 is likewise of cylindrical form. The further actuating fluid channel 128 has a circular cross-sectional area.

The further actuating fluid channel 128 is a through bore which extends in the main body 104 parallel to the main direction of extent 105 of the application unit 102. The through bore extends in the base plate body 110 parallel to the main direction of extent 105 of the application unit 102.

The further actuating fluid channel 128 is arranged between an application fluid channel 130 and the contact-making side 116 of the main body 104. The further actuating fluid channel 128 is arranged in the nozzle-side region. The actuating fluid channel 122 is arranged in the valve-side region.

The actuating fluid channel 122 is assigned to the plurality of valve units 126 of the application unit 102 for supplying actuating fluid. The further actuating fluid channel 128 is assigned to the plurality of valve units 126 of the application unit 102 for discharging actuating fluid.

The actuating fluid channels 122; 128 are fluidically connected to the plurality of valve units 126 by means of feed channels 129. The feed channels 129 are of cylindrical design. The feed channels 129 extend transversely with respect to the main direction of extent 105 of the application unit 102. The feed channel 129 of the actuating fluid channel 122 is arranged perpendicularly with respect to the main direction of extent 105 of the application unit 102. The feed channel 129 of the actuating fluid channel 122 has a larger cross-sectional area than the feed channel 129 to the further actuating fluid channel 128. The diameter of the feed channel 129 of the actuating fluid channel 122 is at least twice as large as the diameter of the feed channel 129 of the further actuating fluid channel 128.

The application fluid channel 130 extends in the center plate body 112 and the base plate body 110. The application fluid channel 130 is formed by the center plate body 112 and the base plate body 110.

The application fluid channel 130 extends parallel to the main direction of extent 105 of the application unit 102 over the entire main body 104. The application fluid channel 130 extends from one end face 106 of the main body 104 as far as the opposite end face 106 of the main body 104.

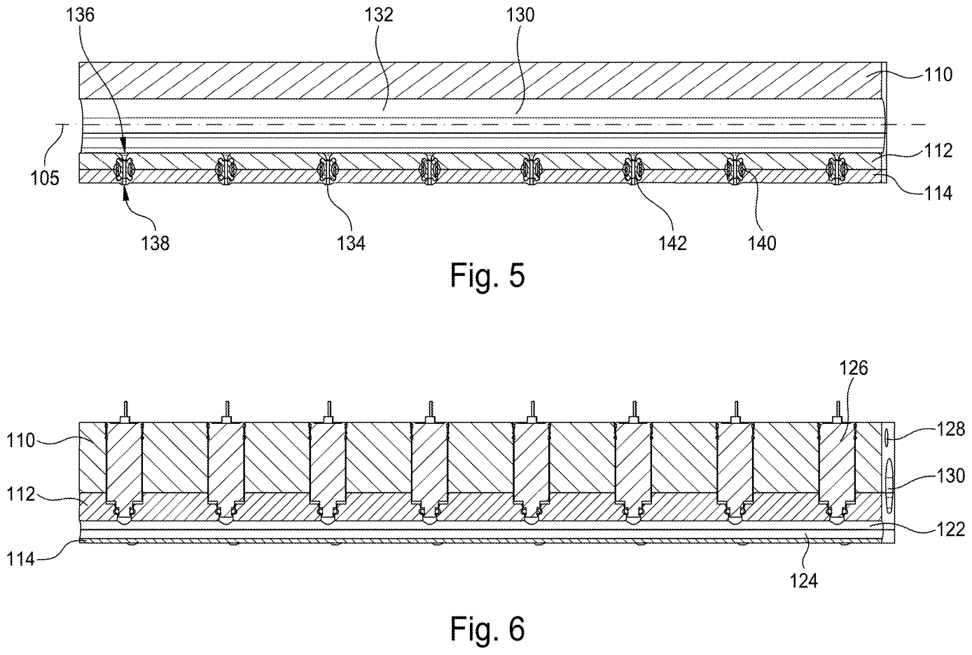

The application fluid channel 130 is of cylindrical form. The application fluid channel 130 has a circular cross-sectional area. The application fluid channel 130 is formed by a recess 132 in the center plate body 112 and by a corresponding recess 132 in the base plate body 110. The recesses 132 are shown, in particular, in FIG. 5. The recess 132 in the base plate body 110 is round. The cross-sectional area of the recess 132 in the base plate body 110 is semicircular. The recess 132 in the center plate body 112 is angular. The cross-sectional area of the recess 132 in the center plate body 112 is trapezoidal. The cross-sectional areas of the recesses 132 in the center plate body 112 and the base plate body 110 together form the cross-sectional area of the application fluid channel 130.

The recesses 132 extend in the center plate body 112 and the base plate body 110 parallel to the main direction of extent 105 of the application unit 102. The recesses 132 extend over the entire main body 104 parallel to the main direction of extent 105 of the application unit 102. The recesses 132 extend from one end face 106 of the main body 104 as far as the opposite end face 106 of the main body 104.

If the main body 104 of the application unit 102 is formed in one piece, the one application fluid channel or the plurality of application fluid channels 130, the one actuating fluid channel or the plurality of actuating fluid channels 122; 128 and the one recess or the plurality of recesses 148 of the cavity 140 can be inserts made of metal and/or plastic.

The application unit 102 comprises a plurality of valve units 126. The plurality of valve units 126 are arranged in linear succession parallel to the main direction of extent 105 of the application unit 102. The plurality of valve units 126 form a valve unit row.

The plurality of valve units 126 extend transversely with respect to the main direction of extent 105 of the application unit 102. The plurality of valve units 126 extend perpendicularly with respect to the main direction of extent 105 of the application unit 102 in the center plate body 112 and the base plate body 110.

The valve unit 126 extends perpendicularly with respect to the main direction of extent 105 of the application unit 102 over the entire base plate body 110. An upper end of the valve unit 126 protrudes from the contact-making side 116 perpendicularly with respect to the main direction of extent 105 of the application unit 102. The valve unit 126 extends perpendicularly with respect to the main direction of extent 105 of the application unit 102 over half of the center plate body 112.

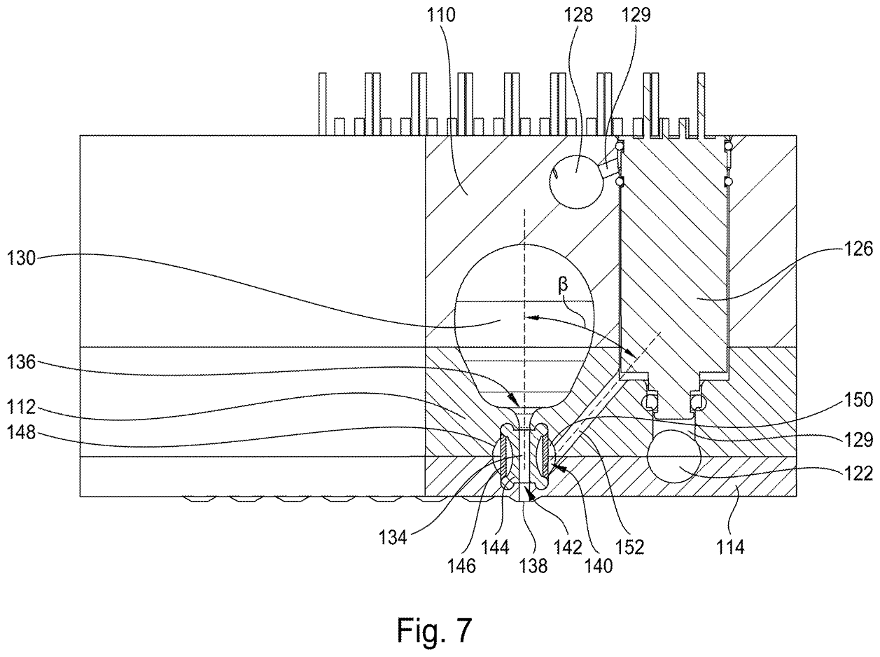

FIGS. 6 and 7 show that the plurality of valve units 126 are fluidically connected to the actuating fluid channel 122. The plurality of valve units 126 are fluidically connected to the further actuating fluid channel 128.

The valve units 126 are valves. A valve unit 126 is at least one valve. In FIGS. 2 and 4, the valve units are arranged in the valve-side region of the main body 104. The valve unit row extends in the valve-side region of the main body 104 along the main direction of extent 105 of the application unit 102. The valve unit row is shown, in particular, in FIGS. 2, 4 and 6.

FIG. 4 shows the recess 132 of the application fluid channel 130 in the center plate body 112. The application fluid channel 130 comprises a plurality of fluid outlet channels 134. A fluid outlet channel 134 comprises an inlet opening 136 and an outlet opening 138. The fluid outlet channel 134 is fluidically connected to the application fluid channel 130. The fluid outlet channel 134 extends perpendicularly with respect to the main direction of extent 105 of the application unit 102 directly below the application fluid channel.

The fluid outlet channel 134 is a nozzle. The nozzle comprises the inlet opening 136 at one end and the outlet opening 138 at a further end. The nozzle extends from the inlet opening 136 as far as the outlet opening 138. As shown in FIG. 4, the inlet opening 136 is arranged in the application fluid channel 130. As shown in FIG. 3, the outlet opening 138 is arranged on the application side 118 of the application unit 102. The nozzle extends perpendicularly with respect to the main direction of extent 105 of the application unit 102 between the application fluid channel 130 and the application side 118 of the application unit 102.

The plurality of fluid outlet channels 134 are arranged in linear succession parallel to the main direction of extent 105 of the application unit 102. The plurality of fluid outlet channels 134 form a fluid outlet channel row. The fluid outlet channel row is arranged immediately below the application fluid channel 130. The inlet openings 136 and the outlet openings 138 of the fluid outlet channels 134 are arranged in linear succession parallel to the main direction of extent 105 of the application unit 102. The plurality of inlet openings 136 and the plurality of outlet openings 138 of the fluid outlet channels 134 each form an outlet opening row and an inlet opening row.

As shown in FIG. 7, the application unit 102 comprises a cavity 140. The cavity 140 is arranged directly below the application fluid channel. The cavity 140 is of cylindrical form. The cylindrical cavity 140 is arranged perpendicularly with respect to the main direction of extent 105 of the application unit 102.

The cavity 140 is formed by the application plate body 114 and the center plate body 112. The cavity 140 is formed by a recess 148 in the center plate body 112 and by a recess 148 in the application plate body 114. The recesses 148 form the spherical cavity 140.

As shown in FIG. 5, the application unit 102 comprises a plurality of cavities 140. A closure unit 142 is arranged in each of the cavities.

The closure unit 142 comprises a closure element 144 and a guide element 146.

The closure element 144 is of sleeve-like form. The guide element 146 surrounds the closure element 144. The closure element 144 is received in the cavity 140 in a force-fitting and form-fitting manner. The closure element 144 can be a rubber cuff which is reversibly deformable. The rubber cuff can, in particular, comprise a boot. The rubber cuff can, in particular, be a flexible sleeve.

The plurality of closure units 142 extend perpendicularly with respect to the main direction of extent 105 of the application unit 102 in the center plate body 112 and the application plate body 114. The plurality of closure units 142 are arranged directly below the application fluid channel 130.

The plurality of closure units 142 are each arranged between the inlet opening 136 and the outlet opening 138 of the fluid outlet channel 134.

As can be seen in FIG. 7, a pressure space 150 extends in the cavity 140 between the closure unit 142 and the main body 104. The pressure space 150 is formed by the closure element 144 and the main body 104 by the center plate body 112 and the application plate body 114. The guide element 146 is arranged in the pressure space 150. The guide element 146 is arranged between the closure element 144 and the main body 104 in the pressure space 150. The application fluid can be supplied to the outlet opening 138 through an interior space of the closure element 144. The interior space of the closure element 144 forms a part of the fluid outlet channel 134. The interior space of the closure element 144 forms the fluid outlet channel 134, in particular the nozzle.

Provision is furthermore made for the application fluid to be guided through the interior space to the respective outlet opening 138.

The respective outlet opening 138 (an outlet opening is illustrated in section by way of example in FIG. 7) is formed by means of the application plate body 114.

The interior space of the respective closure element 144 is shaped as a cylinder, the length of which is greater than the diameter thereof. The cylinder can have a diameter of approximately 0.5 mm to approximately 1 mm. The cylinder preferably has a diameter of approximately 0.7 mm to approximately 0.9 mm.

Alternatively, the cylinder can have a diameter of at least approximately 1 mm to approximately 4 mm. The cylinder preferably has a diameter of approximately 2 mm to approximately 3 mm.

The cylinder can preferably have a circular base surface. Alternatively, the base surface can have an oval base surface, for example in the form of an ellipse.

It can be seen from FIG. 7 that a wall thickness of the closure element 144, proceeding from the center thereof, increases continuously axially along its central axis to the two ends thereof.

However, the wall thickness can additionally vary along the central axis within an imaginary two-dimensional Cartesian coordinate system which is oriented perpendicularly with respect to the central axis and which represents the cross section of the closure element.

Accordingly, the cross section of the respective closure element 144 has two predetermined deformation portions, which can be regarded as two portions within the Cartesian coordinate system, which have a greater wall thickness than the other portions of the cross section.

Such a cross section can be achieved, for example, by means of a circular inner diameter and an elliptical outer shape of the closure element 144. Alternatively, it can be advantageous if the closure element 144 has a circular outer diameter and an elliptical inner shape.

It is thus possible to enable a preferred direction of a deformation of the closure element and/or a correspondingly predefined deformation geometry.

For example, the closure element 144 is formed from an elastomer. The elastomer can be, for example, natural rubber, EPDM, PUR, neoprene, NBR (nitrile butadiene rubber) and/or silicone.

The plurality of closure units 144 are connected to the valve units 126 by means of a plurality of connecting channels 152. FIG. 7, in particular, shows the connecting channel 152. The plurality of connecting channels 152 are arranged between the closure unit 142 and the valve unit 126. The plurality of connecting channels 152 connect the nozzle-side region to the valve-side region. The connecting channel 152 connects the cavity 140 to the valve unit 126.

The connecting channel 152 extends transversely with respect to the main direction of extent 105 of the application unit 102 in the center plate body 112. The connecting channel 152 is arranged at an angle β of less than 90 degrees with respect to the main direction of extent 105 of the application unit 102. The connecting channel 152 and the fluid outlet channel 134 form an angle β of approximately 45 degrees. The plurality of connecting channels 152 extend obliquely with respect to the main direction of extent 105 of the application unit 102 and are arranged in linear succession in parallel.

### LIST OF DESIGNATIONS

100 Application device
102 Application unit
104 Main body
105 Main direction of extent
106 End face of the main body
106a End face of the plate bodies
106b Further end face of the plate bodies
108 Fixing element
110 Base plate body
112 Center plate body
114 Application plate body
116 Contact-making side
118 Application side
120 Plate body stack
122 Actuating fluid channel; compressed air channel
124 Recess of the actuating fluid channel
126 Valve unit
128 Further actuating fluid channel; vacuum channel
129 Feed channel
130 Application fluid channel
132 Recess of the application fluid channel
134 Fluid outlet channel
136 Inlet opening
138 Outlet opening
140 Cavity
142 Closure unit
144 Closure element
146 Guide element
148 Recess of the cavity
150 Pressure space
152 Connection channel
α Angle between an application unit and a fixing element
β Angle between a fluid outlet channel and a connecting channel

1. An application device for applying a fluid to an object, or for applying cement paste to a sand bed, wherein the application device includes one application unit or a plurality of application units, wherein each application unit comprising:
a plurality of closure units for selectively enabling or closing a plurality of fluid outlet channels; and
at least one application fluid channel for supplying application fluid to the closure units; and
one valve unit or a plurality of valve units for actuating the closure units.

2. The application device as claimed in claim 1, wherein each application unit comprises a main body which comprises at least one application plate body, at least one center plate body and at least one base plate body.

3. The application device as claimed in claim 2, wherein:
a) at least one actuating fluid channel extends parallel to a main direction of extent of the application unit in the application plate body and the center plate body, or is formed by the application plate body and the center plate body; and/or
b) at least one actuating fluid channel, or a further actuating fluid channel, or a second of two actuating fluid channels, extends parallel to a main direction of extent of the application unit in the at least one base plate body.

4. The application device as claimed in claim 2, wherein the application fluid channel runs within the center plate body and the base plate body and/or is formed by the center plate body and the base plate body, or wherein the application fluid channel extends parallel to a main direction of extent of the application unit.

5. The application device as claimed in claim 1, wherein the application unit comprises at least one actuating fluid channel, or at least two actuating fluid channels, wherein the at least one actuating fluid channel or the at least two actuating fluid channels is/are assigned to a plurality of valve units of the application unit, or for supplying and/or discharging actuating fluid, or compressed air or a liquid, to or from the valve units.

6. The application device as claimed in claim 1, wherein the at least one valve unit or the plurality of valve units extends/extend transversely, or perpendicularly, with respect to the main direction of extent of the application unit in the center plate body and the base plate body.

7. The application device as claimed in claim 1, wherein the at least one closure unit comprises at least one closure element and at least one guide element, wherein the application fluid can be supplied to at least one outlet opening through an interior space of the at least one closure unit, or of the at least one closure element, and/or wherein
the interior space of the at least one closure element is shaped as a cylinder which has a diameter of approximately 0.5 mm to approximately 1 mm, or of approximately 0.7 mm to approximately 0.9 mm, and/or wherein
the at least one closure element has one or a plurality of predetermined deformation portions.

8. The application device as claimed in claim 1, wherein the at least one closure unit or the plurality of closure units extends/extend transversely, or perpendicularly, with respect to the main direction of extent of the application unit in the center plate body and in the application plate body, wherein the at least one closure unit or the plurality of closure units is/are arranged directly below the application fluid channel.

9. The application device as claimed in claim 1, wherein the main body of the application unit comprises at least one cavity or which is arranged, directly below the application fluid channel, wherein the at least one closure unit is arranged in the at least one cavity, wherein a pressure space extends in the cavity between the closure unit and the main body.

10. The application device as claimed in claim 1, wherein the plurality of closure units are connected to a common actuating fluid channel by means of a plurality of connecting channels, or wherein a fluid connection between the actuating fluid channel and the respective closure unit can be established or interrupted by means of the valve unit assigned to a respective closure unit.

11. The application device as claimed in claim 1, wherein the plurality of valve units are arranged in linear succession parallel to the main direction of extent of the application unit and thereby form a valve unit row, wherein the plurality of closure units are arranged in linear succession parallel to the main direction of extent of the application unit and thereby form a closure unit row, and wherein the valve unit row and the closure unit row are arranged so as to run parallel to one another.

12. The application device as claimed in claim 1, wherein the at least one closure element is of elastic form and deformable in a pressure-dependent manner, wherein the closure element is surrounded by actuating fluid in a state of use of the application device and is thus deformable by varying a pressure of the actuating fluid, or actuable for selectively enabling or closing the associated fluid outlet channel.

13. The application device as claimed in claim 1, wherein the closure units comprise or are pinch valves, and/or in that the valve units comprise or are electric valves, or solenoid valves and/or piezo valves.

14. The application device as claimed in claim 1, wherein the application unit comprises an application fluid circuit or forms a constituent part thereof, whereby a permanent flow of the application fluid can be maintained in the application fluid channel.

15. A method for applying a fluid by means of said application device as claimed in claim 1, wherein the closure unit is actuated hydraulically or pneumatically.
